(19) United States
(12) Patent Application Publication
(10) Pub. No.: US 2026/0164188 A1
(43) Pub. Date: Jun. 11, 2026

(54) SYSTEM AND METHOD FOR PREDICTING MAINTENANCE AND FAILURE OF HEARING DEVICES

(71) Applicant: Starkey Laboratories, Inc., Eden Prairie, MN (US)

(72) Inventors: Piero Iared Rivera Benois, Bad Zwischenahn (DE); Henning Schepker, Oldenburg (DE); Anna Johnson, Hopkins, MN (US); Amit Shahar, Hod Hasharon (IL); Jacques Grange, Wales (GB); Martin McKinney, Minneapolis, MN (US); Kenneth Kragh Jensen, Shakopee, MN (US); Lue Du, Medina, MN (US); Xiaojian Lu, Bryn Mawr, PA (US); Jeffrey Mullins, Richfield, MN (US)

(21) Appl. No.: 19/410,269

(22) Filed: Dec. 5, 2025

Related U.S. Application Data
(60) Provisional application No. 63/730,178, filed on Dec. 10, 2024.

(51) Int. Cl. H04R 25/00; G08B 21/18; H04R 29/00

(52) U.S. Cl. CPC H04R 25/30; G08B 21/185; H04R 25/554; H04R 29/001; H04R 29/004; H04R 2420/07; H04R 2420/09; H04R 2460/11

(57) ABSTRACT

Embodiments are directed to measuring, on a periodic basis by a hearing device, one or more transfer functions, each of the one or more transfer functions comprising a receiver-to-microphone acoustic transfer function of the hearing device. A plurality of health indicators of the hearing device are calculated over time using a measured characteristic of each of the measured transfer functions and a nominal characteristic of each of the measured transfer functions. Using the plurality of health indicators, degradation or failure of any of the receivers, any of the microphones, or a component in an acoustic path between one or more receivers and one or more microphones is detected. One or both of recommended actions and warnings are generated in response to detecting degradation or failure of any of the receivers, any of the microphones, or the component.

This application claims the benefit of U.S. Provisional Application No. 63/730,178, filed Dec. 10, 2024, the disclosure of which is incorporated by reference herein in its entirety.

### TECHNICAL FIELD

This application relates generally to ear-level electronic systems and devices, including hearing devices, personal amplification devices, hearing aids, hearables, and other ear-worn electronic devices.

### SUMMARY

Embodiments are directed to a method implemented a least in part by a hearing device comprising one or more receivers and one or more microphones. The method comprises measuring, on a periodic basis by the hearing device, one or more transfer functions, each of the one or more transfer functions comprising a receiver-to-microphone acoustic transfer function of the hearing device. The method also comprises calculating a plurality of health indicators of the hearing device over time using a measured characteristic of each of the measured transfer functions and a nominal characteristic of each of the measured transfer functions. The method further comprises detecting, using the plurality of health indicators, degradation or failure of any of the receivers, any of the microphones, or a component in an acoustic path between the one or more receivers and the one or more microphones. The method also comprises generating one or both of recommended actions and warnings in response to detecting degradation or failure of any of the receivers, any of the microphones, or the component.

Embodiments are directed to a system comprising a hearing device comprising one or more microphones, one or more receivers, a communication device, and a processor coupled to the one or more microphones, the one or more receivers, and the communication device. The processor is configured to measure, on a periodic basis, one or more transfer functions, each of the measured transfer functions comprising a receiver-to-microphone acoustic transfer function of the hearing device. A server is configured to receive the measured transfer functions from the hearing device. The server is further configured to calculate a plurality of health indicators of the hearing device over time using a measured characteristic of each of the measured transfer functions and a nominal characteristic of each of the measured transfer functions, detect, using the plurality of health indicators, degradation or failure of any of the receivers, any of the microphones, or a component in an acoustic path between the one or more receivers and the one or more microphones, generate one or both of recommended actions and warnings in response to detecting degradation or failure of any of the receivers, any of the microphones, or the component, and communicate one or both of the recommended actions and the warnings to an external system or device.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings wherein:

FIG. 1 illustrates a representative hearing device configured to implement periodic acoustic measurements for predicting maintenance and/or failure of the hearing device in accordance with any of the embodiments disclosed herein;

FIG. 2 illustrates representative hearing devices each configured to implement periodic acoustic measurements for predicting maintenance and/or failure of the hearing device in accordance with any of the embodiments disclosed herein;

FIG. 3 illustrates a method of implementing periodic acoustic measurements for detecting degradation and/or failure of a hearing device in accordance with any of the embodiments disclosed herein;

FIG. 4 illustrates a method of implementing periodic acoustic measurements for detecting degradation and/or failure of a hearing device in accordance with any of the embodiments disclosed herein;

FIG. 5 illustrates a method of implementing periodic acoustic measurements for detecting degradation and/or failure of a hearing device in accordance with any of the embodiments disclosed herein;

FIG. 6 illustrates a representative system for implementing periodic acoustic measurements for detecting degradation and/or failure of a hearing device in accordance with any of the embodiments disclosed herein;

FIG. 7 illustrates a procedure for estimating the remaining useful life and predicting maintenance of a hearing device based on periodic acoustic measurements implemented by the hearing device; and

FIG. 8 illustrates a representative hearing device configured to implement periodic acoustic measurements for predicting maintenance and/or failure of the hearing device in accordance with any of the embodiments disclosed herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Hearing devices can be subject to degradation during use by a wearer of the devices. The degradation can result from foreign material ingress which negatively impacts the performance of the hearing devices. Foreign material ingress can, for example, result from a buildup of earwax on a microphone or a receiver of a hearing device. Embodiments of the disclosure are directed to diagnosing and monitoring the deterioration of hearing devices due to, for instance, foreign material ingress, by exploiting periodic acoustic measurements done by the hearing devices. Advantageously, the periodic acoustic measurements can be performed at home. By monitoring the deterioration of the hearing devices over time, embodiments of the disclosure can estimate the remaining time for the next maintenance/cleaning session and the residual useful life of the hearing devices.

In the context of hearing aids, clinicians presently do not have visibility on the deterioration of the hearing aids of their patients. Hence, the hearing aids are used until the patient detects either a decrease in performance or a malfunction in the device. Embodiments of the disclosure can provide clinicians with day-to-day updates on the deterioration of their patients' hearing aids, useful information to schedule appointments with their patients, increase the life expectancy of the hearing aids, ensure benefit of the hearing aids, and ensure the sound quality of the hearing aids.

Embodiments of the disclosure provide for remotely monitoring the degradation of hearing aids and providing clinicians with estimates of the residual useful life and the remaining time for maintenance so that maintenance (e.g., cleaning) and replacement of the hearing aids can be scheduled before there is a complaint from the patient.

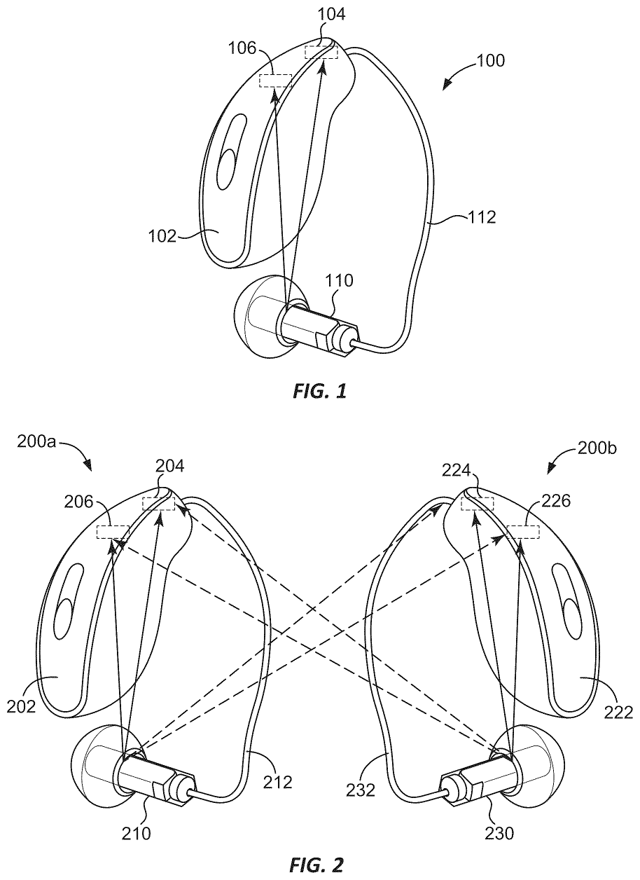

FIG. 1 illustrates a representative hearing device 100 configured to implement periodic measurements for predicting maintenance and/or failure of the hearing device 100 in accordance with any of the embodiments disclosed herein. The hearing device 100 shown in FIG. 1 is a receiver-in-canal (RIC) device which includes a behind-the-ear component 102, a receiver 110, and a cable 112 connecting the receiver 110 to the behind-the-ear component 102. The behind-the-ear component 102 includes two microphones 104, 106.

According to the embodiment shown in FIG. 1, the hearing device 100 is configured to measure, on a periodic basis, two transfer functions, each of which defines a receiver-to-microphone acoustic transfer function of the hearing device 100. A first transfer function is associated with the receiver 110 and microphone 104. A second transfer function is associated with the receiver 110 and microphone 106. It is noted that the hearing device 100 can include two receivers and two or more microphones, with an acoustic transfer function being defined for each unique pairing of receiver and microphone.

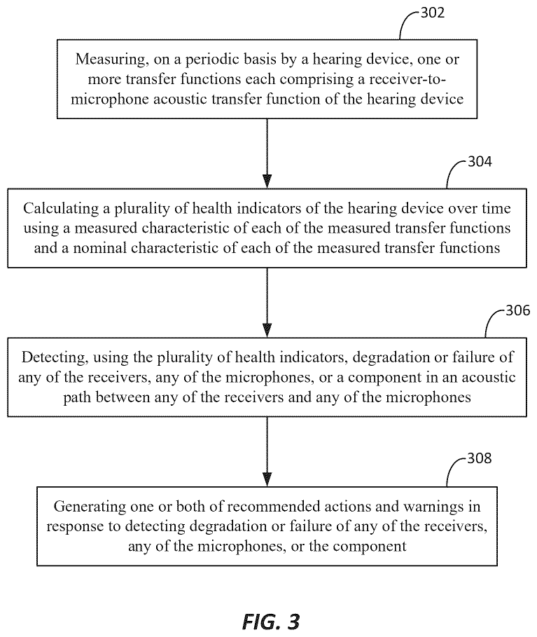

FIG. 2 illustrates representative hearing devices 200a, 200b each configured to implement periodic acoustic measurements for predicting maintenance and/or failure of the hearing devices 200a, 200b in accordance with any of the embodiments disclosed herein. The hearing devices 200a, 200b shown in FIG. 2 are RIC devices. The hearing device 200a includes a behind-the-ear component 202, a receiver 210, and a cable 212 connecting the receiver 210 to the behind-the-ear component 202. The behind-the-ear component 202 includes two microphones 204, 206. The hearing device 200b includes a behind-the-ear component 222, a receiver 230, and a cable 232 connecting the receiver 230 to the behind-the-ear component 222. The behind-the-ear component 222 includes two microphones 224, 226.

According to some embodiments, there are four transfer functions associated with the pair of hearing devices 200a, 200b, each of which defines a receiver-to-microphone acoustic transfer function. A first transfer function is associated with receiver 210 and microphone 204. A second transfer function is associated with receiver 210 and microphone 206. A third transfer function is associated with receiver 230 and microphone 224. A fourth transfer function is associated with receiver 230 and microphone 226.

According to other embodiments, eight transfer functions are associated with the pair of hearing devices 200a, 200b, each of which defines a receiver-to-microphone acoustic transfer function. The first four transfer functions are those described in the preceding paragraph. Four additional cross-device transfer functions can be defined. A fifth transfer function is associated with receiver 210 and microphone 224. A sixth transfer function is associated with receiver 210 and microphone 226. A seventh transfer function is associated with receiver 230 and microphone 204. An eighth transfer function is associated with receiver 230 and microphone 206.

It is understood that the number of receiver-to-microphone acoustic transfer functions described above is for illustrative purposes. Different types of hearing devices may have a different number of receiver-to-microphone acoustic transfer functions. The location of the microphones may differ and may include different types of microphones (e.g., an inward-facing microphone, a microphone situated at a different location on the behind-the-ear component or on the cable).

The hearing devices illustrated in FIG. 1 and FIG. 2 may be configured to perform periodic (e.g., once per day, every other day, or on a weekly basis) acoustic measurements according to the methods shown in FIGS. 3-5. Other types of hearing devices can be configured to perform periodic acoustic measurements according to the methods shown in FIGS. 3-5. Depending on the number of receivers and microphones of a particular hearing device, the number of receiver-to-microphone acoustic transfer functions can vary, such as between one and eight (or more) transfer functions.

According to some embodiments, the method shown in FIG. 3 involves measuring 302, on a periodic basis by a hearing device, one or more transfer functions each comprising a receiver-to-microphone acoustic transfer function of the hearing device. The method also involves calculating 304 a plurality of health indicators of the hearing device over time using a measured characteristic of each of the measured transfer functions and a nominal characteristic of each of the measured transfer functions. The measured characteristic can be a frequency response of each of the measured transfer functions. The nominal characteristic can be a nominal frequency response of each of the measured transfer functions.

The method further involves detecting 306, using the plurality of health indicators, degradation or failure of any of the receivers, any of the microphones, or a component in an acoustic path between any of the receivers and any of the microphones. The component, for example, can be a cracked open faceplate, a receiver housing with a fissure, or be clogged partially obstructed by debris accumulation. The method also involves generating 308 recommended actions and/or warnings in response to detecting degradation or failure of any of the receivers, any of the microphones, or the component.

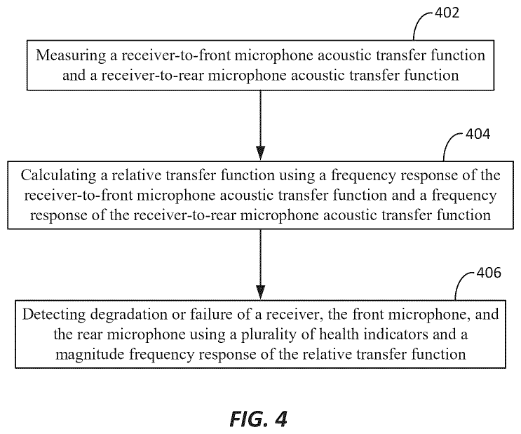

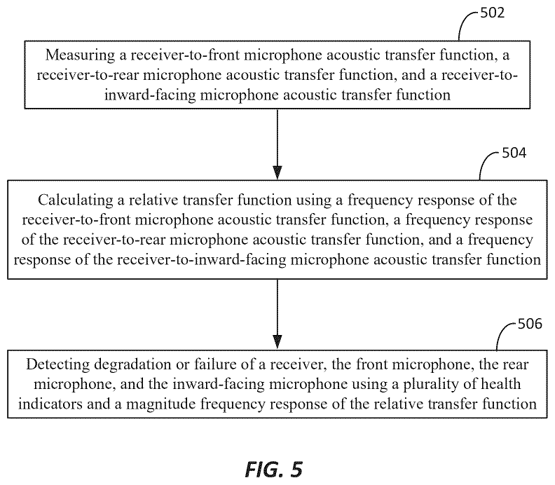

FIG. 4 illustrates a method of performing periodic acoustic measurements by a hearing device in accordance with some embodiments. The method shown in FIG. 4 involves a hearing device with a front microphone, a rear microphone, and a receiver. The method involves measuring 402 a receiver-to-front microphone acoustic transfer function and a receiver-to-rear microphone acoustic transfer function. The method also involves calculating 404 a relative transfer function using a frequency response of the receiver-to-front microphone acoustic transfer function and a frequency response of the receiver-to-rear microphone acoustic transfer function. The method further involves detecting 406 degradation or failure of the receiver, the front microphone, and the rear microphone using a plurality of health indicators (see FIG. 3) and a magnitude frequency response of the relative transfer function. The relative transfer function can define a classification feature which can be used to generate insights related to the deterioration or failure of a specific transducer.

FIG. 5 illustrates a method of performing periodic acoustic measurements by a hearing device in accordance with some embodiments. The method shown in FIG. 5 involves a hearing device with a front microphone, a rear microphone, an inward-facing microphone, and a receiver. The method involves measuring 502 a receiver-to-front microphone acoustic transfer function, a receiver-to-rear microphone acoustic transfer function, and a receiver-to-inward-facing microphone acoustic transfer function. The method also involves calculating 504 a relative transfer function using a frequency response of the receiver-to-front microphone acoustic transfer function, a frequency response of the receiver-to-rear microphone acoustic transfer function, and a frequency response of the receiver-to-inward-facing microphone acoustic transfer function. The method further involves detecting 506 degradation or failure of a receiver, the front microphone, the rear microphone, and the inward-facing microphone using a plurality of health indicators (see FIG. 3) and a magnitude frequency response of the relative transfer function.

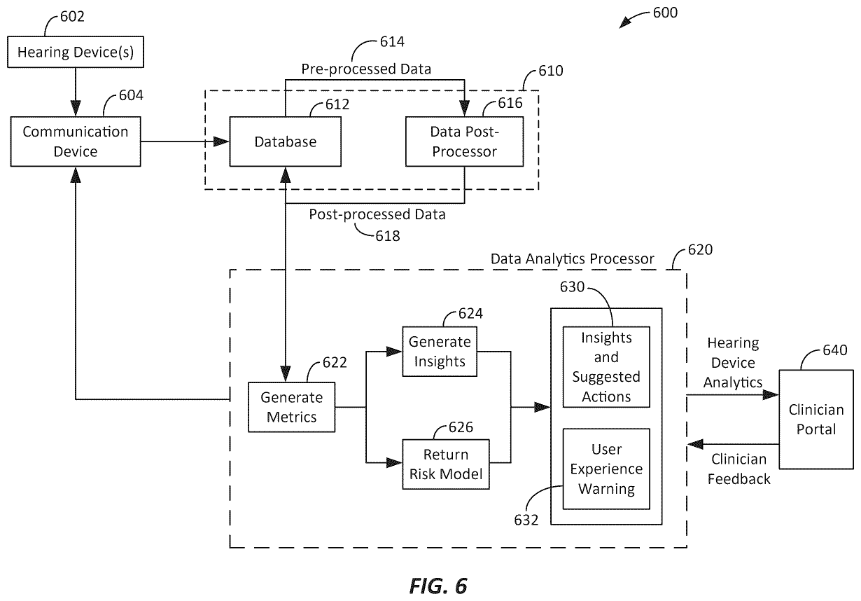

FIG. 6 illustrates a representative system for performing periodic acoustic measurements by a hearing device in accordance with some embodiments. The system 600 includes a single hearing device or a pair of hearing devices 602 configured to perform periodic acoustic measures as described herein. For example, and in accordance with an illustrative embodiment, the hearing devices 602 are hearing aids which can perform acoustic measurements on a periodic basis, such as on a daily basis. The hearing aids 602 can be placed in a charger (e.g., at night), after which the receiver-to-microphone acoustic transfer functions are measured and logged in the hearing aids 602. The hearing aids 602 can store the transfer functions measured over the course of several days, such as a week.

In an alternative embodiment, the hearing aids 602 can be powered by disposable batteries, in which case the periodic acoustic measurements can be made with the hearing aids 602 lying horizontally on a surface (e.g., a table). The hearing aids 602 can detect that the devices are lying horizontally (e.g. using an accelerometer or inertial measurement unit) over a prolonged period time, and that the environment is quiet enough for the acoustic measurements to be successful.

The hearing aids 602 are configured to communicate the receiver-to-microphone acoustic transfer functions to a server 610 either directly or via an intermediate communication device 604, such as a smartphone, a tablet or a PC. The server 610 can be a server maintained by the hearing aid manufacturer. Once a connection is made, the measured transfer functions logged in the hearing aids 602 are transferred to a database 612 of the server 610. The acoustic measurement data transferred to the database 612 can be considered raw or pre-processed acoustic measurement data 614. The pre-processed data 614 stored in the database 612 is processed (e.g., cleaned) by a data post-processor 616 of the server 610. The data post-processor 616 is configured to implement post-processing scripts to clean the pre-processed data 614 and to generate post-processed data 618. Data tables of the database 612 are updated using the post-processed data 618 for access by a data analytics processor 620.

The data analytics processor 620 is configured to generate metrics 622 using the measured receiver-to-microphone transfer functions stored as post-processed data 618 in the database 612. The metrics 622 generated by the data analytics processor 620 can include current health indicators of the hearing aids 602 and classification features.

The health indicators (e.g., defining an acoustic degradation index) can be generated using each of the measured transfer functions and a nominal characteristic of each of the measured transfer functions. For example, the health indicators can be generated using a frequency response of each of the measured transfer functions and a nominal frequency response of each of the transfer functions. The nominal characteristic of the measured transfer functions can be obtained from a variety of sources, such as an initial measurement made in the clinic, a database, during manufacturing calibration, or when the hearing aids 602 are recharged for the first time by the user at home.

When neglecting the cross-device transfer functions of a pair of hearing aids 602, each of which includes two microphones and a receiver according to an embodiment, the current health indicator for time tᵢ and a given hearing aid 602 can be defined as:

$${x}_{i} = {\sum }_{k = 0}^{{L}_{FFT} - 1} {\vert {B}_{mic 1}^{nominal} ( {Ω}_{k} ) - {B}_{mic 1} ( {Ω}_{k} , {t}_{i} ) \vert}^{2} + {\vert {B}_{mic 2}^{nominal} ( {Ω}_{k} ) - {B}_{mic 2} ( {Ω}_{k} , {t}_{i} ) \vert}^{2} ,$$

$$where {B}_{mic 1}^{nominal} ( {Ω}_{k} )$$

denotes the nominal frequency response of the receiver-to-mic1 transfer function, B_{mic1} (Ωₖ, tᵢ) denotes the frequency response of the measured receiver-to-mic1 transfer function,

$${B}_{mic 2}^{nominal} ( {Ω}_{k} )$$

denotes the nominal frequency response of the receiver-to-mic2 transfer function, B_{mic2}(Ωₖ, tᵢ) denotes the frequency response of the measured receiver-to-mic2 transfer function, and L_{FFT} denotes the length of the discrete Fourier transform used to calculate the frequency responses at frequencies Ωₖ, where k={0, . . . , L_{FFT}−1}. The nominal frequency response of the receiver to mic1

$${B}_{mic 1}^{nominal} ( {Ω}_{k} )$$

and the receiver-to mic2

$${B}_{mic 2}^{nominal} ( {Ω}_{k} )$$

transfer functions can be obtained in a manner discussed above.

The classification features can be defined as the frequency responses B_{mic1}(Ωₖ, tᵢ) and B_{mic2}(Ωₖ, tᵢ), and a combination of both, which can be relative transfer functions, Fᵢ(Ωₖ), defined as:

$${F}_{i} ( {Ω}_{k} ) = 20 \cdot {log}_{10} \vert \frac{{B}_{mic 2} ( {Ω}_{k} , {t}_{i} )}{{B}_{mic 2} ( {Ω}_{k} , {t}_{i} )} \vert$$

The data analytics processor 620 can implement one or more anomaly detection algorithms that use the classification features to generate insights 624 associated with the deterioration or failure of a specific transducer (e.g., a microphone, a receiver) of the hearing aids 602. Anomaly detection can, for example, involve detecting a deviation between the frequency response of a measured receiver-to-microphone transfer function for a particular acoustic path and the nominal frequency response of the receiver-to-microphone transfer function for the particular acoustic path. The deviation, if detected, can be compared to a predetermined threshold to detect the presence or absence of an anomaly.

Moreover, using the health indicators and the output of the anomaly detection algorithm, a predictive maintenance algorithm can estimate when the next maintenance session should be conducted and the remaining useful life of a specific hearing aid 602. Therefore, the output of the return risk model 626 for a specific hearing aid 602 can be calculated.

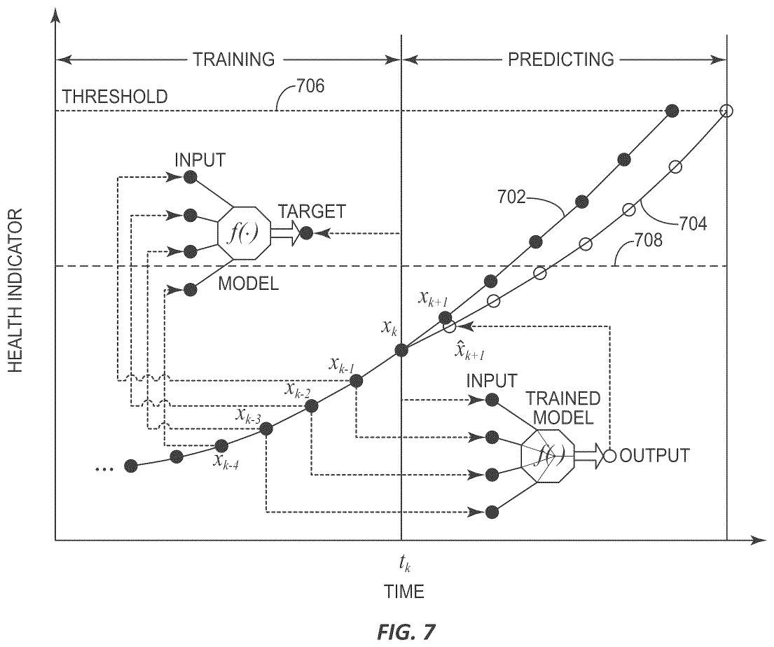

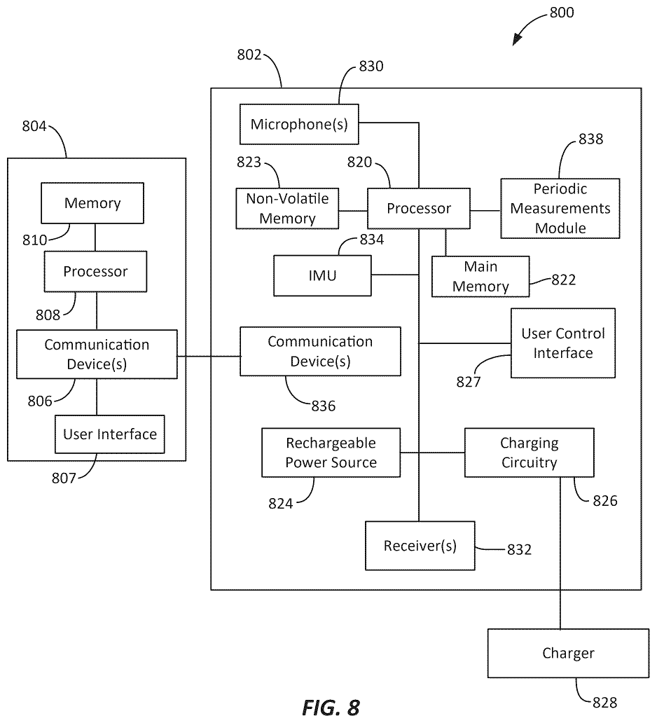

In FIG. 7, an example of how a representative predictive maintenance algorithm operates is shown. The predictive maintenance algorithm, implemented by the data analytics processor 620, considers the health indicator observed during monitoring over time (curve 702) and the predicted health indicator trend (curve 704) as predicted by a Trained model at the present moment t_k. Threshold 706 is calculated in a manner discussed below using failed hearing aids that have been returned to the hearing aid manufacturer by the users.

First, a prediction model is trained to predict the following health indicator given a subset of previous health indicator values. This is done with all health indicator values in the record for a particular hearing aid until the current time tₖ. Alternatively, one can start this training with a prediction model that has been pre-trained with other hearing aids of the same hearing aid product-family.

After the training is completed, the trained prediction model is used to iteratively predict the next health indicators (xₖ₊₁, xₖ₊₂, xₖ₊₃, . . . ), until the health indicator reaches a specified threshold (e.g., Threshold in FIG. 7). This threshold can be defined as the mean health indicator of a set R of hearing aids 602 of the same hearing aid product-family that have been returned to the hearing aid manufacturer due to failure. The hearing aids 602 can be collected, for example, by the technical support of the hearing aid manufacturer. This specified threshold can be calculated by the following equation:

$${x}_{failure} = \frac{1}{R} {\sum }_{r = 1}^{R} {\sum }_{k = 0}^{{L}_{FFT} - 1} {\vert {B}_{mic 1}^{nominal} ( {Ω}_{k} ) - {B}_{m}^{r} ( {Ω}_{k} ) \vert}^{2} + {\vert {B}_{mic 2}^{nominal} ( {Ω}_{k} ) - {B}_{m}^{r} ( {Ω}_{k} ) \vert}^{2} ,$$

$$where {B}_{mic 1}^{r} ( {Ω}_{k} )$$

is the frequency response of the receiver-to-mic1 transfer function measured by the hearing aid manufacturer with device r from the set R of returned devices, and

$${B}_{mic 2}^{r} ( {Ω}_{k} )$$

is the frequency response of the receiver-to-mic2 transfer function measured by the hearing aid manufacturer with device r from the set R of returned devices. Additionally, the time for the next maintenance session can be estimated in parallel to the residual useful life by setting a second threshold 708. This threshold 708 for maintenance sessions is logically lower than the threshold 706 for estimating the residual useful life of the hearing aid 602.

The insights and return risk model outputs are combined and mapped to suggested actions 630 and warnings 632 that are used to update the user's hearing aid health record stored in the database 612. The suggested actions 630 can include an indication that maintenance (e.g., cleaning) of the hearing device 602 should be scheduled by the clinician. The warnings 632 can include an indication that a particular transducer (microphone, receiver) of a hearing device 602 is failing or has failed, and that maintenance, repair or replacement of the hearing device 602 is recommended. The hearing aid health record is accessible through a portal 640 of the hearing aid manufacturer by the clinicians over the internet. Using these insights and warnings, the clinicians can schedule with anticipation the maintenance (e.g., cleaning), repair, and replacement of the hearing aids 602.

The portal 640 can be accessed by clinicians via the internet as part of a daily routine to determine the current state of the hearing aids of individual patients. The portal 640 can be accessed by a clinician using a computing device, such as a tablet or a PC. The portal 640 can provide access to an electronic medical record system which contains a record for each patient indicating the status of a patient's hearing aids. The status can indicate whether or not maintenance or replacement of a hearing aid is required. The record can indicate which hearing aid requires maintenance or replacement. The status of individual transducers (e.g., microphone, receiver) can also be included in the record.

For example, a green text box can be displayed on an interface of the computing device indicating that the hearing aids are operating properly. A green text box can also indicate that maintenance (e.g., cleaning) is required in the near future, such as in eight weeks. A yellow text box can indicate that maintenance is required in the near term, such as in two weeks. A red text box can indicate that replacement of a hearing aid is required. Based on hearing aid status, the clinician can contact the patient (e.g., via a phone call) to schedule an appointment so that the appropriate corrective action can be taken (e.g., maintenance or replacement).

In FIG. 8, a block diagram illustrates a system and ear-worn hearing device 800 in accordance with any of the embodiments disclosed herein. The hearing device 800 includes a housing 802 configured to be worn in, on, or about an ear of a wearer. The hearing device 800 shown in FIG. 8 can represent a single hearing device configured for monaural or single-ear operation or one of a pair of hearing devices configured for binaural or dual-ear operation. The hearing device 800 shown in FIG. 8 includes a housing 802 within or on which various components are situated or supported. The housing 802 can be configured for deployment on a wearer's ear (e.g., a behind-the-ear device housing), within an ear canal of the wearer's ear (e.g., an in-the-ear, in-the-canal, invisible-in-canal, or completely-in-the-canal device housing) or both on and in a wearer's ear (e.g., a receiver-in-canal or receiver-in-the-ear device housing).

The hearing device 800 includes a processor 820 operatively coupled to a main memory 822 and a non-volatile memory 823. The processor 820 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 820 can include or be operatively coupled to main memory 822, such as RAM (e.g., DRAM, SRAM). The processor 820 can include or be operatively coupled to non-volatile (persistent) memory 823, such as ROM, EPROM, EEPROM or flash memory. The non-volatile memory 823 is configured to store instructions (e.g., module 838) that are executable by the processor 820 for performing periodic acoustic measurements as previously described.

The hearing device 800 includes an audio processing facility (also referred to as an audio processor circuit) operably coupled to, or incorporating, the processor 820. The audio processing facility includes audio signal processing circuitry (e.g., analog front-end, analog-to-digital converter, digital-to-analog converter, DSP, and various analog and digital filters), a microphone arrangement 830, and one or more receivers 832. The one or more receivers 832 produce amplified sound inside of the ear canal. The microphone arrangement 830 can include one or more discrete microphones or a microphone array(s) (e.g., configured for microphone array beamforming). Each of the microphones of the microphone arrangement 830 can be situated at different locations of the housing 802, and can include an inward-facing microphone. It is understood that the term microphone used herein can refer to a single microphone or multiple microphones unless specified otherwise.

The hearing device 800 may also include a user interface with a user control interface 827 operatively coupled to the processor 820. The user control interface 827 is configured to receive an input from the wearer of the hearing device 800. The input from the wearer can be any type of user input, such as a touch input, a gesture input, or a voice input.

The hearing device 800 also includes a periodic measurements module 838 operably coupled or integral to the processor 820. The module 838 can be implemented in software, hardware, or a combination of hardware and software. The module 838 can be used to perform periodic acoustic measurements that include sending a signal (e.g., one or more tones, wideband noise) through the receiver 832 and sensing a response at one or more microphones 830. The response is used by the module 838 to measure one or more transfer functions each comprising a receiver-to-microphone acoustic transfer function. As previously discussed, the measured one or more transfer functions are used to calculate a plurality of health indicators that are used to detect degradation or failure of the receiver 832, any of the microphones 830, or a component in an acoustic path between the receiver 832 and any of the microphones 830. In response to detecting degradation or failure of the receiver 832, any of the microphones 830, or the component, recommended actions and/or warnings can be generated.

The hearing device 800 can include one or more communication devices 836. For example, the one or more communication devices 836 can include one or more radios coupled to one or more antenna arrangements that conform to an IEEE 802.8 (e.g., Wi-Fi®) or Bluetooth® (e.g., BLE, Bluetooth® 4.2, 5.0-5.4 or later) specification, for example. In addition, or alternatively, the hearing device 800 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 836 may also include wired communications, e.g., universal serial bus (USB) and the like.

The communication device 836 is operable to allow the hearing device 800 to communicate with an external computing device 804, e.g., a mobile device such as smartphone, laptop computer, tablet, etc. The external computing device 804 includes a communications device 806 that is compatible with the communications device 836 for point-to-point or network communications. The external computing device 804 includes its own processor 808 and memory 810, the latter of which may encompass both volatile and non-volatile memory. A user interface 807 facilitates interactions between the external computing device 804 and the hearing device 800

When communicatively coupled to the hearing device 800, the external computing device 804 can receive one or more transfer functions measured by the hearing device 800. The external computing device 804 can be configured to use the measured one or more transfer functions to calculate a plurality of health indicators and use the health indicators to detect degradation or failure of the receiver 832, any of the microphones 830, or a component in an acoustic path between the receiver 832 and any of the microphones 830. In response to detecting degradation or failure of the receiver 832, any of the microphones 830, or the component, the external computing device 804 can generate recommended actions and/or warnings, which can be presented on the user interface 807 and/or communicated to a server. Alternatively, the external computing device 804 can communicate the measured one or more transfer functions to a server, and the server can use the transfer functions to detect degradation or failure of the receiver 832, any of the microphones 830, or the component, and generate recommended actions and/or warnings.

The hearing device 800 also includes a power source, which can be a conventional battery, a rechargeable battery (e.g., a lithium-ion battery), or a power source comprising a supercapacitor. In the embodiment shown in FIG. 8, the hearing device 800 includes a rechargeable power source 824 which is operably coupled to power management circuitry for supplying power to various components of the hearing device 800. The rechargeable power source 824 is coupled to charging circuitry 826. The charging circuitry 826 is electrically coupled to charging contacts on the housing 802 which are configured to electrically couple to corresponding charging contacts of a charger 828 when the hearing device 800 is placed in the charger. The charger 828 may be a charging case with a lid that can be closed after placing the hearing device(s) 800 inside the case. With the hearing device(s) 800 situated in the case, the hearing device(s) may implement the periodic acoustic measurements as previously described.

The hearing device 800 can include one or more sensors that can be configured to detect a physiological characteristic of the wearer or an environmental condition of an environment of the wearer. For example, the device 800 can include an inertial measurement unit (IMU) 834 that can be configured to detect motion of the wearer and/or manipulations of the charger as is further described herein.

As previously discussed, the periodic acoustic measurements can be made with the hearing devices placed in a charger, such as a portable charger with a lid. In some embodiments, the periodic acoustic measurements can be made while the user is wearing the hearing devices. For example, the periodic acoustic measurements can be made directly after the hearing devices have been inserted in the user's ears, between manual or automatic memory changes, after manual changes of volume, or during music streaming.

In some embodiments, the periodic acoustic measurements are made by the hearing devices, and these measurements are transferred to a server. The server includes a data analytics processor that implements processes for detecting deterioration or failure of a hearing device, estimating when preventative maintenance is required, and estimating the remaining useful life of the hearing devices. In some embodiments, the analytics processor can be a processor of a computing device (e.g., a tablet, a PC), and the processes described above with regard to the server can be implemented by the computing device. In other embodiments, the periodic acoustic measurements, detecting deterioration or failure of a hearing device, estimating when preventative maintenance is required, and estimating the remaining useful life of the hearing devices are implemented by one or more processors of the hearing devices. These data can be transferred from the hearing devices (e.g., directly or via a computing device) to a server that supports a clinician portal as previously described.

Consider the case in which the hearing device implements periodic acoustic measurements and determines that transducer degradation is detected, where the transducer degradation is found to be a simple attenuation of input or output. The hearing device can make a proactive decision to increase the prescribed hearing aid gain (e.g., a frequency-specific gain) to compensate for the input or output attenuation. In some cases, the hearing device can communicate a message to a computing device requesting the user to increase the hearing aid gain. In other cases, the hearing device can set a flag to notify the clinician (e.g., via a computing device and a clinician portal) of the transducer degradation and the implemented compensation.

In some implementations, a check can be made by the hearing device to determine whether the microphones (e.g., front and rear microphones) of the hearing device are functional prior to implementing periodic acoustic measurements inside a charger. The hearing device can be configured to calculate a metric indicative of similarity, coherence, or correlation between the microphone signals while sensing the sound present in the environment. If the calculated metric is lower than expected (e.g., lower than a predetermined threshold), when considering the distance between the microphones and the design of the hearing device and charger, then a specific microphone or more than one microphone has failed. This information can be used during the diagnostic procedure that determines the health of the hearing device transducers.

According to some implementations, the hearing device can be configured to implement logic to determine whether a periodic acoustic measurement procedure should be repeated, delayed or skipped, or whether to disregard the measurement results. The periodic acoustic measurement can be implemented with the hearing device placed in a charger. The hearing device can be configured to detect manipulations of the charger based on signals produced by an IMU of the hearing device or transients in the microphone signals captured during the measurement. Based on the IMU signals or the microphone signal transients, the hearing device can determine whether the periodic acoustic measurement procedure should be repeated, delayed or skipped, or whether to disregard the measurement results.

In some implementations, the hearing device can be configured to perform an a priori signal-to-noise ratio (SNR) estimation based on the largest microphone signal. This microphone signal can be compared to a threshold, which can be a minimum SNR required for the periodic acoustic measurement. The a priori SNR estimation can be used to adapt (e.g., reduce) the measurement stimulus level (e.g., receiver output) based on the comparison with the minimum SNR requirement, which serves to minimize annoyance to the user.

Representative embodiments of the disclosure are defined in the following Examples. Below there is provided a non-exhaustive listing of non-limiting examples. Any one or more of the features of these examples may be combined with any one or more features of another example, embodiment, or aspect described herein.

Example Ex1. A method implemented a least in part by a hearing device comprising one or more receivers and one or more microphones comprises measuring, on a periodic basis by the hearing device, one or more transfer functions, each of the one or more transfer functions comprising a receiver-to-microphone acoustic transfer function of the hearing device, and calculating a plurality of health indicators of the hearing device over time using a measured characteristic of each of the measured transfer functions and a nominal characteristic of each of the measured transfer functions. The method also comprises detecting, using the plurality of health indicators, degradation or failure of any of the receivers, any of the microphones, or a component in an acoustic path between the one or more receivers and the one or more microphones, and generating one or both of recommended actions and warnings in response to detecting degradation or failure of any of the receivers, any of the microphones, or the component.

Example Ex2. The method according to Ex1, comprising estimating a residual useful life of the hearing device using a prediction model trained using the plurality of health indicators.

Example Ex3. The method according to Ex1 or Ex2, comprising estimating a residual useful life of the hearing device using a prediction model pre-trained using health indicators associated with other hearing devices of the same hearing device family.

Example Ex4. The method according to any one or combination of Ex1-Ex3, comprising estimating a time for maintenance of the hearing device in response to detecting degradation of any of the one or more receivers and the one or more microphones.

Example Ex5. The method according to any one or combination of Ex1-Ex4, comprising communicating one or both of the recommended actions and the warnings to a remote system or device.

Example Ex6. The method according to any one or combination of Ex1-Ex5, comprising communicating the measured transfer functions to a server configured to perform the calculating, detecting, and generating operations.

Example Ex7. The method according to any one or combination of Ex1-Ex5, comprising communicating the measured transfer functions to a computing device configured to perform the calculating, detecting, and generating operations.

Example Ex8. The method according to any one or combination of Ex1-Ex5, wherein the hearing device is configured to perform the calculating, detecting, and generating operations.

Example Ex9. The method according to any one or combination of Ex1-Ex8, wherein the method is implemented by a pair of hearing devices and comprises measuring one or more receiver-to-microphone acoustic transfer functions for each of the hearing devices individually, and measuring one or more cross-device receiver-to-microphone acoustic transfer functions using the pair of the hearing devices.

Example Ex10. The method according to any one of combination of Ex1-Ex9, wherein the hearing device comprises a front microphone and a rear microphone, and the method comprises measuring a receiver-to-front microphone acoustic transfer function and a receiver-to-rear microphone acoustic transfer function, calculating a relative transfer function using a frequency response of the receiver-to-front microphone acoustic transfer function and a frequency response of the receiver-to-rear microphone acoustic transfer function, and detecting degradation or failure of any of the one or more receivers, the front microphone, and the rear microphone using the plurality of health indicators and a magnitude frequency response of the relative transfer function.

Example Ex11. The method according to any one or combination of Ex1-Ex9, wherein the hearing device comprises a front microphone, a rear microphone, and an inward-facing microphone, and the method comprises measuring a receiver-to-front microphone acoustic transfer function, a receiver-to-rear microphone acoustic transfer function, and a receiver-to-inward-facing microphone acoustic transfer function, calculating a relative transfer function using a frequency response of the receiver-to-front microphone acoustic transfer function, a frequency response of the receiver-to-rear microphone acoustic transfer function, and a frequency response of the receiver-to-inward-facing microphone acoustic transfer function, and detecting degradation or failure of any of the one or more receivers, the front microphone, the rear microphone, and the inward-facing microphone using the plurality of health indicators and a magnitude frequency response of the relative transfer function.

Example Ex12. The method according to any one or combination of Ex1-Ex11, wherein measuring the transfer functions is implemented in response to detecting connection between the hearing device and a charging unit.

Example Ex13. The method according to any one or combination of Ex1-Ex12, wherein measuring the transfer functions is implemented once per day, every other day, or on a weekly basis.

Example Ex14. The method according to any one or combination of Ex1-Ex13, wherein the recommended actions and warnings comprise an indication of foreign material ingress affecting at least one of the receivers and/or at least one of the microphones.

Example Ex15. The method according to any one or combination of Ex1-Ex14, comprising detecting the degradation as attenuation of an input or output of a receiver or a microphone, and compensating for the attenuation using a frequency-specific gain and/or setting a flag to notify a clinician of the degradation and the compensation.

Example Ex16. The method according to any one or combination of Ex1-Ex15, comprising determining that two or more microphones are functional prior to the measuring operation by calculating a metric indicative of similarity, coherence or correlation between microphone signals while sensing sound present in an environment, comparing the metric to a threshold, and determining that one or more of the microphones has failed in response to the metric falling below the threshold.

Example Ex17. The method according to any one or combination of Ex1-Ex16, comprising measuring the one or more transfer functions with the hearing device positioned in a charger, detecting manipulation of the charger while measuring the one or more transfer functions, and determining whether to repeat, delay or skip the measuring operation or to discard the measurements.

Example Ex18. The method according to any one or combination of Ex1-Ex17, comprising performing an a priori signal-to-noise ratio (SNR) estimation based on a largest microphone signal, comparing the SNR estimation to a minimum SNR threshold, and adjusting a receiver output based on the comparison.

Example Ex19. A system comprises a hearing device comprising one or more microphones, one or more receivers, a communication device, and a processor coupled to the one or more microphones, the one or more receivers, and the communication device. The processor is configured to measure, on a periodic basis, one or more transfer functions, each of the measured transfer functions comprising a receiver-to-microphone acoustic transfer function of the hearing device. The system comprises a server configured to receive the measured transfer functions from the hearing device. The server is further configured to calculate a plurality of health indicators of the hearing device over time using a measured characteristic of each of the measured transfer functions and a nominal characteristic of each of the measured transfer functions, detect, using the plurality of health indicators, degradation or failure of any of the receivers, any of the microphones, or a component in an acoustic path between the one or more receivers and the one or more microphones, generate one or both of recommended actions and warnings in response to detecting degradation or failure of any of the receivers, any of the microphones, or the component, and communicate one or both of the recommended actions and the warnings to an external system or device.

Example Ex20. The system according to Ex19, wherein the server is configured to estimate a residual useful life of the hearing device using a prediction model trained using the plurality of health indicators.

Example Ex21. The system according to Ex19 or Ex20, wherein the server is configured to estimate a residual useful life of the hearing device using a prediction model pre-trained using health indicators associated with other hearing devices of the same hearing device family.

Example Ex22. The system according to any one or combination of Ex19-Ex21, wherein the server is configured to estimate a time for maintenance of the hearing device in response to detecting degradation of any of the one or more receivers and the one or more microphones.

Example Ex23. The system according to any one or combination of Ex19-Ex22, wherein the processor is configured to measure one or more receiver-to-microphone acoustic transfer functions for each of a pair of hearing devices individually, and measure one or more cross-device receiver-to-microphone acoustic transfer functions using the pair of the hearing devices.

Example Ex24. The system according to any one or combination of Ex19-Ex23, wherein the hearing device comprises a front microphone and a rear microphone, the processor is configured to measure a receiver-to-front microphone acoustic transfer function and a receiver-to-rear microphone acoustic transfer function, and the server is configured to calculate a relative transfer function using a frequency response of the receiver-to-front microphone acoustic transfer function and a frequency response of the receiver-to-rear microphone acoustic transfer function, and detect degradation or failure of any of the one or more receivers, the front microphone, or the rear microphone using the plurality of health indicators and a magnitude frequency response of the relative transfer function.

Example Ex25. The system according to any one or combination of Ex19-Ex24, wherein the hearing device comprises a front microphone, a rear microphone, and an inward-facing microphone, the processor is configured to measure a receiver-to-front microphone acoustic transfer function, a receiver-to-rear microphone acoustic transfer function, and a receiver-to-inward-facing microphone acoustic transfer function, and the server is configured to calculate a relative transfer function using a frequency response of the receiver-to-front microphone acoustic transfer function, a frequency response of the receiver-to-rear microphone acoustic transfer function, and a frequency response of the receiver-to-inward-facing microphone acoustic transfer function, and detect degradation or failure of any of the one or more receivers, the front microphone, the rear microphone, or the inward-facing microphone using the plurality of health indicators and a magnitude frequency response of the relative transfer function.

Example Ex26. The system according to any one or combination of Ex19-Ex25, wherein the processor is configured to measure the transfer functions in response to detecting connection between the hearing device and a charging unit.

Example Ex27. The system according to any one or combination of Ex19-Ex26, wherein the processor is configured to measure the transfer functions once per day, every other day, or on a weekly basis.

Example Ex28. The system according to any one or combination of Ex19-Ex27, wherein the recommended actions and warnings comprise an indication of foreign material ingress affecting the one or more receivers and/or the one or more microphones.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The terms “connected” or “coupled” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

What is claimed is:

1. A method implemented at least in part by a hearing device comprising one or more receivers and one or more microphones, the method comprising:
measuring, on a periodic basis by the hearing device, one or more transfer functions, each of the one or more transfer functions comprising a receiver-to-microphone acoustic transfer function of the hearing device;
calculating a plurality of health indicators of the hearing device over time using a measured characteristic of each of the measured transfer functions and a nominal characteristic of each of the measured transfer functions;
detecting, using the plurality of health indicators, degradation or failure of any of the receivers, any of the microphones, or a component in an acoustic path between the one or more receivers and the one or more microphones; and
generating one or both of recommended actions and warnings in response to detecting degradation or failure of any of the receivers, any of the microphones, or the component.

2. The method of claim 1, comprising estimating a residual useful life of the hearing device using a prediction model trained using the plurality of health indicators.

3. The method of claim 1, comprising estimating a residual useful life of the hearing device using a prediction model pre-trained using health indicators associated with other hearing devices of the same hearing device family.

4. The method of claim 1, comprising estimating a time for maintenance of the hearing device in response to detecting degradation of any of the one or more receivers and the one or more microphones.

5. The method of claim 1, wherein the method is implemented by a pair of hearing devices and comprises:
measuring one or more receiver-to-microphone acoustic transfer functions for each of the hearing devices individually; and
measuring one or more cross-device receiver-to-microphone acoustic transfer functions using the pair of the hearing devices.

6. The method of claim 1, wherein the hearing device comprises a front microphone and a rear microphone, and the method comprises:
measuring a receiver-to-front microphone acoustic transfer function and a receiver-to-rear microphone acoustic transfer function;
calculating a relative transfer function using a frequency response of the receiver-to-front microphone acoustic transfer function and a frequency response of the receiver-to-rear microphone acoustic transfer function; and
detecting degradation or failure of any of the one or more receivers, the front microphone, and the rear microphone using the plurality of health indicators and a magnitude frequency response of the relative transfer function.

7. The method of claim 1, wherein the hearing device comprises a front microphone, a rear microphone, and an inward-facing microphone, and the method comprises:
measuring a receiver-to-front microphone acoustic transfer function, a receiver-to-rear microphone acoustic transfer function, and a receiver-to-inward-facing microphone acoustic transfer function;
calculating a relative transfer function using a frequency response of the receiver-to-front microphone acoustic transfer function, a frequency response of the receiver-to-rear microphone acoustic transfer function, and a frequency response of the receiver-to-inward-facing microphone acoustic transfer function; and
detecting degradation or failure of any of the one or more receivers, the front microphone, the rear microphone, and the inward-facing microphone using the plurality of health indicators and a magnitude frequency response of the relative transfer function.

8. The method of claim 1, wherein measuring the transfer functions is implemented in response to detecting connection between the hearing device and a charging unit.

9. The method of claim 1, wherein the recommended actions and warnings comprise an indication of foreign material ingress affecting at least one of the receivers and/or at least one of the microphones.

10. The method of claim 1, comprising detecting the degradation as attenuation of an input or output of a receiver or a microphone, and compensating for the attenuation using a frequency-specific gain and/or setting a flag to notify a clinician of the degradation and the compensation.

11. The method of claim 1, comprising:
determining that two or more microphones are functional prior to the measuring operation by calculating a metric indicative of similarity, coherence or correlation between microphone signals while sensing sound present in an environment;
comparing the metric to a threshold; and
determining that one or more of the microphones has failed in response to the metric falling below the threshold.

12. The method of claim 1, comprising:
measuring the one or more transfer functions with the hearing device positioned in a charger;
detecting manipulation of the charger while measuring the one or more transfer functions; and
determining whether to repeat, delay or skip the measuring operation or to discard the measurements.

13. A system, comprising:
a hearing device comprising:
one or more microphones;
one or more receivers;
a communication device; and
a processor coupled to the one or more microphones, the one or more receivers, and the communication device, the processor configured to measure, on a periodic basis, one or more transfer functions, each of the measured transfer functions comprising a receiver-to-microphone acoustic transfer function of the hearing device; and
a server configured to receive the measured transfer functions from the hearing device, the server further configured to:
calculate a plurality of health indicators of the hearing device over time using a measured characteristic of each of the measured transfer functions and a nominal characteristic of each of the measured transfer functions;
detect, using the plurality of health indicators, degradation or failure of any of the receivers, any of the microphones, or a component in an acoustic path between the one or more receivers and the one or more microphones;
generate one or both of recommended actions and warnings in response to detecting degradation or failure of any of the receivers, any of the microphones, or the component; and
communicate one or both of the recommended actions and the warnings to an external system or device.

14. The system of claim 13, wherein the server is configured to estimate a residual useful life of the hearing device using a prediction model trained using the plurality of health indicators.

15. The system of claim 13, wherein the server is configured to estimate a residual useful life of the hearing device using a prediction model pre-trained using health indicators associated with other hearing devices of the same hearing device family.

16. The system of claim 13, wherein the server is configured to estimate a time for maintenance of the hearing device in response to detecting degradation of any of the one or more receivers and the one or more microphones.

17. The system of claim 13, wherein the processor is configured to:
measure one or more receiver-to-microphone acoustic transfer functions for each of a pair of hearing devices individually; and
measure one or more cross-device receiver-to-microphone acoustic transfer functions using the pair of the hearing devices.

18. The system of claim 13, wherein:
the hearing device comprises a front microphone and a rear microphone;
the processor is configured to measure a receiver-to-front microphone acoustic transfer function and a receiver-to-rear microphone acoustic transfer function; and
the server is configured to:
calculate a relative transfer function using a frequency response of the receiver-to-front microphone acoustic transfer function and a frequency response of the receiver-to-rear microphone acoustic transfer function; and
detect degradation or failure of any of the one or more receivers, the front microphone, or the rear microphone using the plurality of health indicators and a magnitude frequency response of the relative transfer function.

19. The system of claim 13, wherein:
the hearing device comprises a front microphone, a rear microphone, and an inward-facing microphone;
the processor is configured to measure a receiver-to-front microphone acoustic transfer function, a receiver-to-rear microphone acoustic transfer function, and a receiver-to-inward-facing microphone acoustic transfer function; and
the server is configured to:
calculate a relative transfer function using a frequency response of the receiver-to-front microphone acoustic transfer function, a frequency response of the receiver-to-rear microphone acoustic transfer function, and a frequency response of the receiver-to-inward-facing microphone acoustic transfer function; and
detect degradation or failure of any of the one or more receivers, the front microphone, the rear microphone, or the inward-facing microphone using the plurality of health indicators and a magnitude frequency response of the relative transfer function.

20. The system of claim 13, wherein the recommended actions and warnings comprise an indication of foreign material ingress affecting the one or more receivers and/or the one or more microphones.
